(19) United States
(12) Patent Application Publication
(10) Pub. No.: US 2006/0229411 A1
(43) Pub. Date: Oct. 12, 2006

(54) Hot melt pressure sensitive adhesives based on blends of styrene/butadiene copolymers

(76) Inventors: Stephen Hatfield, Corinth, TX (US); Jason D. Gillen, Plano, TX (US); David Wei Zhang, Plano, TX (US)

Correspondence Address: HENKEL CORPORATION, THE TRIAD, SUITE 200, 2200 RENAISSANCE BLVD., GULPH MILLS, PA, 19406, US

(21) Appl. No.: 11/100,056

(22) Filed: Apr. 6, 2005

(51) Int. Cl. C08L 53/00

(52) U.S. Cl. 525/88

(57) ABSTRACT

Hot melt pressure sensitive adhesives useful in a wide range of end-use applications may be formulated without the use of isoprene-containing polymers using combinations of different styrene/butadiene copolymers including at least one S-B-S triblock copolymer.

### FIELD OF THE INVENTION

The present invention relates to hot melt pressure sensitive adhesives (HMPSA) based on linear A-B-A triblock copolymers blended with A-B diblock copolymers (wherein the B component is polybutadiene and the A component is a polystyrene) and/or multiblock copolymers of styrene and butadiene and/or random copolymers of styrene and butadiene (styrene butadiene rubbers). Such adhesives are useful for tapes, pre-applied labels, container labeling, laminating, product assembly, positioning adhesives for femcare products and disposable article assembly.

### DISCUSSION OF THE RELATED ART

A hot melt adhesive is in general an essentially water- and solvent-free adhesive, which is applied on a substrate out of a molten state. The setting of the adhesive happens when the melted adhesive cools and solidifies. A hot melt pressure-sensitive adhesive (HMPSA) is an adhesive that retains high surface tackiness over time. In other words, a HPMSA has a theoretically infinite open time. The bonding force of the HPMSA is derived from the ability of the adhesive to be compatible with the surface of both the substrate and the bonded materials. The adhesive bond arises from the compatibility of the adhesive mass with both the object and the substrate and the internal cohesiveness of the adhesive mass.

A number of hot melt pressure sensitive adhesives based on block copolymers of styrene and isoprene have been described in the literature and are available from several commercial sources. These S-I-S-based adhesives are generally preferred for many applications due to their good performance and properties. However, in recent years the cost of manufacturing such adhesives has increased significantly due to increases in the price of isoprene, which has been in short supply. It would therefore be desirable to develop hot melt pressure sensitive adhesives which are not based on isoprene-containing polymers but yet have characteristics resembling those of the conventional S-1-S containing adhesives.

### SUMMARY OF THE INVENTION

The present invention provides a hot melt pressure sensitive adhesive (HMPSA) comprising:
a) at least one styrene/butadiene block copolymer having a melt flow index of less than about 12 g/10 min, a linear triblock structure, and a styrene content of about 20 to about 35 weight percent;
b) at least one butadiene-based rubber selected from the group consisting of (i) styrene/butadiene random copolymers containing about 15 to about 35 weight percent styrene, (ii) styrene/butadiene multiblock copolymers containing about 35 to about 55 weight percent styrene and (iii) styrene/butadiene diblock copolymers containing about 15 to about 40 weight percent styrene;
c) at least one tackifier resin;
d) optionally, at least one plasticizer;
e) optionally, at least one filler; and
f) optionally, at least one stabilizer and/or UV-absorber.

The melt viscosity of the adhesive is generally from about 500 mPas to about 250,000 mPas at 150° C. The glass transition temperature (Tg) of the adhesive may be from about −20° to about 40° C. Additionally, the adhesive may have a G′ from about 1×10⁵ to about 6×10⁶ dynes per cm² at 25° C. The weight ratio of component a): component b) may be, for example, from about 10:1 to about 1:5.

The adhesive compositions of the present invention have the advantage of not requiring the use of any isoprene-containing polymers (such as styrene/isoprene block copolymers). Thus, in one embodiment, the adhesive contains less than 1 weight % isoprene-containing polymer. In other embodiments, the adhesive is essentially free or entirely free of any isoprene-containing polymer.

### DETAILED DESCRIPTION OF CERTAIN EMBODIMENTS OF THE INVENTION

The hot melt adhesives of the present invention contain at least one styrene/butadiene block copolymer having a melt flow index of less than 12 g/10 min (as determined by ASTM-D 1238-95), a linear triblock structure, and a styrene content of 20 to 35 weight percent. Such block copolymers generally will be present in amounts of from about 5 to about 25 percent or, in some embodiments, from about 7 to about 20 percent of the total weight of the adhesive.

Each styrene block may have a number average molecular weight in one embodiment ranging from about 1000 to about 75,000, in another embodiment from 5000 to about 50,000, and in yet another embodiment from about 8000 to about 20,000. The butadiene block typically has a number average molecular weight of about 25,000 to 300,000, between 30,000 and 250,000 in another embodiment, between about 35,000 and 200,000 in still another embodiment. Suitable S-B-S block copolymers of this type are obtainable from Dexco Polymers under the tradenames VECTOR 2518, 8508 and 7400 (which contains 33 weight % mineral oil) and from Kraton Polymers under the tradename KRATON 1101.

The preparation of linear triblock copolymers of styrene and butadiene suitable for use as component a) of the present invention may be carried out by any method known in the art, including, for example, anionic polymerization. Typically, the first step of the polymerization process involves contacting the styrene monomer and an organolithium compound (initiator) in the presence of an inert diluent thereby forming a living polymer having the simplified structure A-Li (where A represents a polystyrene block). Next, usually once essentially all the styrene monomer has been consumed, the living polymer is contacted with butadiene monomer to produce a living polymer having the simplified structure A-B-Li (where A represents a polystyrene block and B represents a polybutadiene block). The living polymer may be then reacted (usually once essentially all the butadiene has been consumed) with additional styrene monomer to form the desired A-B-A (S-B-S) linear triblock copolymer. Alternatively, two molecules of the living polymer are coupled by reacting with a difunctional coupling agent to form the linear triblock copolymer. The difunctional coupling agent contains two functional groups per molecule capable of reacting with the anionic living polymer such as, for example, halide groups.

Component b) of the adhesive composition of the present invention is comprised of one or more butadiene-based rubbers selected from the group consisting of (i) styrene/butadiene random copolymers containing about 15 to about 35 weight percent styrene, (ii) styrene/butadiene multiblock copolymers containing about 35 to about 55 weight percent styrene and (iii) styrene/butadiene diblock copolymers containing about 15 to about 40 weight percent styrene. Component b) may represent from about 1 to about 25% or, in another embodiment, from about 2 to about 20%, of the total weight of the adhesive composition.

In one embodiment of the invention, component b) contains or consists essentially of one or more S-B (styrene-butadiene) diblock copolymers containing from about 15 to about 45 weight percent styrene (in polymerized form). S-B diblock copolymers may be prepared using standard methods known in the art such as living anionic polymerization in which styrene or butadiene is first homopolymerized to form one block, followed by homopolymerization of the other monomer to form the second block, followed by termination or quenching of the anionic polymerization. The diblock copolymer may have a “tapered” structure or mixed random-block structure wherein the polybutadiene block contains a minor amount of copolymerized styrene. Diblock copolymers suitable for use in the present invention are also available from commercial sources such as, for example, certain of the materials sold under the tradename BUNA BL by Lanxess. The weight ratio of component a): styrene/butadiene diblock copolymer in one embodiment of the invention may be from about 8:1 to about 1:1.

In one embodiment of the invention, components a) and b) of the adhesive composition are simultaneously provided through the use of a styrene/butadiene block copolymer composition containing both a linear triblock copolymer of styrene and butadiene (S-B-S) and a diblock copolymer of styrene and butadiene (S-B). The amount of diblock copolymer in such compositions may be controlled, as is well known in the art, by different methods. One approach is to add an amount of difunctional coupling agent which is less than the necessary stoichiometric amount for a complete coupling of the A-B-Li living polymer intermediate. Another approach involves partial (i.e., less than stoichiometric) addition of a quenching agent and subsequent addition of a difunctional coupling agent. Styrene/butadiene block copolymer compositions containing a mixture of both S-B diblock and S-B-S triblock copolymers are also available from a number of commercial sources. Such styrene/butadiene block copolymer compositions may be supplemented with a “pure” S-B-S triblock copolymer or a “pure” S-B diblock copolymer to adjust the weight ratio of component a) to component b) within the desired range. For example, a block copolymer composition may be utilized which is comprised of 40 to 80 weight percent SB (styrene-butadiene) diblock copolymer and 20 to 60 weight percent SBS (styrene-butadiene-styrene) triblock copolymer. Examples of suitable block copolymer compositions of this type which are available commercially include SOL TE 6320 from EniChem Elastomers. This block copolymer composition may be blended or combined with a “pure” S-B-S triblock copolymer (for example, from about 25 to about 55 parts by weight triblock copolymer per 10 parts by weight of the block copolymer composition) to adjust the component a): component b) ratio as desired.

The adhesive composition of the present invention may comprise, as part or all of component b), a styrene/butadiene rubber (SBR), that is, a random copolymer of styrene and butadiene. The SBR should preferably contain from about 15 to about 35 weight percent styrene (the balance being butadiene). Styrene/butadiene rubbers are commonly prepared by emulsion copolymerization using free radical initiators, but other copolymerization methods such as solution copolymerization may also be utilized. The term “random copolymer” is used herein to include not only completely random copolymers of styrene and butadiene, but also copolymer compositions containing some “block” character or a homopolymer of one monomer in addition to polymer having a completely random distribution of the two different monomers. For example, random copolymers suitable for use in the present invention may contain some polystyrene homopolymer. Such styrene/butadiene random copolymers are well known in the art and are widely available from a number of commercial sources, including, for example, SOLPRENE S-1205 (Phillips Petroleum Company), which contains 25 weight % styrene (including 17.5 weight % styrene in “block” form) and has a Mooney viscosity (ML1+4) of 47. Preferably, the viscosity of the random copolymer is sufficiently low to permit blending with the other components of the hot melt pressure sensitive adhesive. For example, the Mooney viscosity is preferably not greater than about 80 or more preferably not greater than about 60. The weight ratio of component a): styrene/butadiene random copolymer is from about 1.5:1 to about 1:3, in one embodiment of the invention.

Component b) of the adhesive composition of the present invention may alternatively or additionally be comprised of a linear multiblock styrene/butadiene copolymer containing about 35 to about 55 weight % styrene. “Multiblock” copolymers of this type are block copolymers containing at least two polystyrene blocks and at least two polybutadiene blocks. The multiblock copolymer may have a “pure” block structure (where each block contains only a single type of monomer, i.e., either styrene or butadiene) or a “tapered” block structure (where, for example, the polybutadiene blocks contain a relatively small amount of copolymerized styrene or one block is transitioned to an adjacent block by feeding into the polymerization reaction mixture a mixture of different monomers before switching to a feed consisting only of the monomer that is to constitute the adjacent block or by starting the feed of the second monomer before all the first monomer in the reaction mixture has been consumed). The structures of such copolymers are often generally expressed as (A-B)ₙ, where n is at least two, or A-B-A-B-A (it being understood that the multiblock copolymer may contain more than five blocks and that the endblocks are not necessarily polystyrene blocks). Multiblock copolymers of this type are available from commercial sources including, for example, STEREON 840A, STEREON 841A, and STEREON 842A from Firestone Polymers, SOL T 169 from EniChem Elastomers, and TUFPRENE A from Asahi. In one embodiment of the invention, the number average molecular weight of the multiblock copolymer is from about 50,000 to about 100,000. The melt flow of the multiblock copolymer may, for example, range from about 6 to about 16 (ASTM D1238). The weight ratio of component a): styrene/butadiene multiblock copolymer is from about 2:1 to about 1:3, in one embodiment of the invention.

In certain embodiments of the invention, the combined weight of component a) and component b) represents from about 12 to about 28 percent of the total weight of the adhesive composition.

One or more compatible tackifier resins are present in the adhesives of the present invention in amounts, for example, of from about 30% to about 80% by weight or about 50 to about 75% by weight. Illustrative tackifier resins may be selected from the group consisting of: aliphatic petroleum resins and the hydrogenated derivatives thereof, aromatic petroleum resins and the hydrogenated derivatives thereof, aliphatic/aromatic petroleum resins and the hydrogenated derivatives thereof, hydrocarbon resins, styrene resins, alpha-methyl styrene resins, polyterpene resins, copolymers and terpolymers of natural terpene resins, pentaerythritol esters of wood, gum, and tall-oil rosins, glycerol esters of wood, gum, and tall-oil rosins, and mixed esters of rosins and mixtures. More particularly, the useful tackifer resins include any compatible resins or mixtures of said resins from the following group:
(1) natural and modified rosins such as, for example, gum rosin, wood rosin, tall oil rosin, distilled rosin, hydrogenated rosin, and polymerized rosin;
(2) glycerol, pentaerythritol (PE), and mixed glycol esters of natural and modified rosins such as, for example, the glycerol esters of wood rosin or tall oil rosin, the PE ester of hydrogenated rosin, and the phenolic-modified PE ester of rosin having a softening point, as determined by ASTM method E28-58T, of about 30° C. to about 125° C.;
(3) copolymers and terpolymers of terpenes, such as styrene-terpenes and alpha-methyl styrene-terpenes, having softening points from 60° C. to about 125° C.;
(4) polyterpene resins having softening points of from about 110° C. to about 125° C.;
(5) phenolic-modified terpene resins and the hydrogenated derivatives thereof having a softening point of about 60° C. to about 130° C.;
(6) aliphatic petroleum hydrocarbon resins having a softening point of about 5° C. to about 140° C.;
(7) alicyclic petroleum hydrocarbon resins and the hydrogenated derivatives thereof; and
(8) endblock reinforcing resins based on homopolymers, copolymers, and terpolymers of styrene, alpha-methylstyrene, vinyl toluene, and phenylene oxide having a softening point from 70° C. to 165° C.

“Endblock resins” are substantially aromatic and compatible with the endblock “A” of the A-B-A copolymer.

The preferred tackifier resins for the present invention are tackifier resins having a ring and ball softening point of from about 80° C. to 125° C. In preferred embodiments of the invention, the tackifier resin is selected from the group consisting of pentaerythritol esters of rosin, aromatically-modified aliphatic and cycloaliphatic resins, hydrogenated aromatically-modified cycloaliphatic resins, styrenated terpene resins and mixtures thereof, especially those tackifier resins having softening points within the range of from about 80° C. to 125° C. Examples of such tackifier resins which are commercially available include SYLVALITE RE 100L (Arizona Chemical), ESCOREZ 5615, 5600, 2394 and 2596 (ExxonMobil Chemical), WINGTACK 86 and ET (Goodyear Chemical), and SYLVARES ZT5100 (Arizona Chemical).

In another embodiment of the invention, the tackifier resin utilized is a C5-C9 hydrocarbon tackifier resin or aromatically-modified C5 hydrocarbon tackifier resin containing about 10 to about 30 weight % (or about 18 to about 24 weight %) of one or more C9 compounds and/or vinyl aromatic compounds such as styrene, a glass transition temperature of from about 15° C. to about 45° C. (or about 25° C. to about 45° C. or about 32° C. to about 38° C.), and a ring and ball softening point of from about 20° C. to about 90° C. (or about 50° C. to about 90° C. or about 60° C. to about 80° C.). Such resins may be prepared by copolymerization of at least one C5 olefin (including mono- and/or diolefins such as isoprene, 2-methyl-1-butene, 2-methyl-2-butene, cyclopentene, 1-pentene, cis- and trans-2-pentene, cyclopentadiene, cis- and trans-1,3-pentadiene and the like) with at least one monoalkenyl aromatic hydrocarbon (e.g., styrene, alpha-methyl styrene, indene). The preparation of such tackifier resins may be carried out, for example, in accordance with the teachings of U.S. Pat. No. 4,623,698, incorporated herein by reference in its entirety. Tackifier resins of this type may also be produced by adaptation of the methods taught in the following United States patents (each of which is incorporated herein by reference in its entirety): U.S. Pat. Nos. 6,605,680; 6,232,418; 2,750,353; 2,754,288; 4,008,360; 4,952,639; 5,652,308; 5,571,867; 5,284,891; 4,766,169; 6,214,935; 6,106,939; and 6,218,588.

One or more plasticizers may also be present in the hot melt adhesives of the present invention. Typically, the adhesive will contain a total of from about 1 to about 30 weight % or about 5 to about 25 weight % plasticizer. Plasticizers are generally added for purposes of viscosity control and/or improving wetting and specific adhesion to substrates. These plasticizers are preferably selected from the group consisting of naphthenic oils, phthalate and adipate esters, propylene oligomers, butene oligomers, isoprene oligomers, hydrogenated isoprene oligomers, butadiene oligomers, benzoate esters, and vegetable and animal oils and derivatives thereof. Fully hydrogenated plasticizers can be selected from paraffinic hydrocarbon oils (including those available, for example, under the tradename PRIMOL from ExxonMobil Chemicals), polyisobutylenes, poly-1-butene oils and hydrogenated naphthenic oils. Preferably, the polyisobutylenes have a molecular weight ranging from about 600 to 5000, more preferably from 800 to 4000. Typically they are highly viscous liquids at room temperature. Suitable polyisobutylenes are available under the tradename “Parapol” from EXXON Chemicals or under the tradename “Oppanol” from BASF. Prefered plasticizers are paraffinic oils with viscosities of 100 to 600 mPas, preferably 150 to 300 mPas at 25° C.

One or more waxes may optionally be present in the pressure sensitive hot melt adhesives of the present invention in total amounts ranging from 0% to about 10% by weight. Waxes may be used to reduce the surface tack of the adhesive without appreciably decreasing its adhesive bonding characteristics. These waxes may also be used to reduce the blocking of the composition without affecting the temperature performance. Suitable waxes can, for example, be selected from the group consisting of paraffin waxes, microcrystalline waxes, Fischer-Tropsch waxes, polyethylene waxes, ethylene vinyl acetate copolymer waxes, oxidized polyethylene waxes, hydrogenated castor oil waxes and derivatives thereof, and polypropylene waxes. Useful waxes include low molecular weight (e.g., Mn 1000-6000) polyethylene having hardness values, as determined by ASTM method D-1321, of from about 0.1 to 120 and ASTM softening points of from about 65° C. to 120° C. Petroleum waxes may be also be used such as paraffin waxes having melting points of from about 55° C. to about 75° C. and microcrystalline waxes having a melting points of from about 55° C. to about 95° C. (as determined by ASTM method D 127-60). Atactic polypropylenes are also suitable; typically, they have a ring and ball softening point of from about 120° C. to 160° C. Other suitable waxes include synthetic waxes made by polymerizing carbon monoxide and hydrogen such as Fischer-Tropsch waxes and polyolefin waxes. As used herein, the term “polyolefin wax” refers to polymers comprised of olefinic monomer units, including such polymers having ring and ball softening points of 95° C. to 175° C. Each of these wax diluents is solid at room temperature. Other useful waxes include hydrogenated animal, fish and vegetable fats and oils such as hydrogenated tallow, lard, soya oil, cottonseed oil, castor oil, cod liver oil, and the like which are solid at ambient temperature. These hydrogenated materials are often referred to in the adhesives industry as “animal or vegetable waxes.”

Stabilizers or antioxidants utilized for the present invention may be any of the substances known in the art to be effective in retarding the oxidation or degradation of polymers, including, for example, high molecular weight hindered phenols and multifunctional phenols. Hindered phenols are well known to those skilled in the art to be effective primary stabilizers for styrene-butadiene block copolymers. Typical commercially available stabilizers of these types are supplied by Ciba-Geigy under the tradenames IRGANOX 1010 and IRGANOX 1076. Useful secondary stabilizers include phosphorus- and sulfur-containing compounds, such as tris-(p-nonylphenyl)-phosphite (TNPP) and bis(2,4-di-tert-butylphenyl)4,4′-diphenylene-diphosphonite and di-stearyl-3,3′-thiodipropionate (DSTDP). Stabilizer(s) may represent from 0.1 to about 2.5, preferably from about 0.2 to about 1, % by weight of the hot melt pressure sensitive adhesive of this invention.

Other optional ingredients may also be added to the adhesives of the present invention providing that these ingredients do not adversely affect the desired characteristics of the adhesive. Such other ingredients may include fillers, pigments, other block copolymers; homopolymers, copolymers and terpolymers of ethylene including ethylene vinyl acetate copolymers, ethylene n-butyl acrylate copolymers and ethylene methacrylate copolymers; interpolymers of ethylene having at least one C₃ to C₂₀ alpha-olefin and homopolymers, copolymers and terpolymers of propylene to mention only some examples.

In one embodiment of the invention, the adhesive composition is comprised of from about 6 to about 12 weight % linear S-B-S triblock copolymer containing about 25 to about 35 weight % styrene and having an MFI of less than about 2 g/10 min, about 11 to about 19 weight % of a random styrene/butadiene copolymer containing about 20 to about 30 weight % styrene (a portion of which, e.g., about 15 to about 20% by weight of the copolymer, may optionally be present in block or homopolymer form) and having a Mooney viscosity of from about 35 to about 60, about 11 to about 19 weight % of a hydrocarbon oil plasticizer (preferably, naphthenic oil plasticizer), about 30 to about 49 weight % of a pentaerythritol ester of rosin tackifier resin having a ring and ball softening point of from about 90 to about 105° C., and about 15 to about 25 weight % of an aromatic-modified aliphatic tackifier resin having a ring and ball softening point of from about 85 to about 100° C. A styrene/butadiene diblock copolymer may additionally be present, for example, in an amount of from about 0.1 to about 3 weight %. Such a composition is particularly useful as a pressure sensitive adhesive for tapes and labels.

In another embodiment of the invention, the adhesive composition is comprised of about 16 weight % to about 27 weight % of hydrocarbon oil plasticizer (preferably, naphthenic oil and/or mineral oil plasticizers), about 9 to about 15 weight % of a linear S-B-S triblock copolymer containing about 25 to about 35 weight % styrene and having an MFI of less than about 2 g/10 min, about 1 to about 6 weight % of an S-B diblock containing from about 15 to about 45 weight % styrene, and about 45 to about 80 weight % total of a mixture of at least one aromatically-modified C5 hydrocarbon tackifier resin having a softening point of from about 90 to about 100° C., and at least one pentaerythritol ester of rosin tackifier resin having a softening point of from about 90 to about 105° C. The weight ratio of aromatically-modified C5 hydrocarbon tackifier resin to pentaerythritol ester of rosin tackifier resin may, for example, be from about 3:1 to about 1:2. Such a composition is particularly useful as a pressure sensitive hot melt adhesive in the construction of disposable articles containing nonwovens.

In another embodiment, the adhesive composition is comprised of about 10 to about 18 weight % hydrocarbon oil plasticizer (preferably, naphthenic and/or mineral oil plasticizers), about 6 to about 13 weight % of a linear multiblock styrene/butadiene block copolymer containing about 40 to about 50 weight % styrene, about 6 to about 11 weight % of a linear S-B-S triblock copolymer containing about 25 to about 35 weight % styrene and having an MFI of less than about 2 g/10 min, and about 50 to about 85 weight % of one or more aromatically-modified cycloaliphatic hydrocarbon tackifier resins (this term including hydrogenated aromatically-modified cycloaliphatic hydrocarbon tackifier resins) having ring and ball softening points of from about 95 to about 125° C. Such compositions are especially useful as pressure sensitive hot melt adhesives for attaching elastic to nonwovens in the construction of disposable articles.

In another embodiment of the invention, the adhesive composition is comprised of about 19 to about 32 weight % of hydrocarbon oil plasticizer (preferably, naphthenic oil and/or mineral oil plasticizers), about 8 to about 15 weight % of a linear S-B-S triblock copolymer containing about 25 to about 35 weight % styrene and having an MFI of less than about 2 g/10 min, about 1 to about 6 weight % of an S-B diblock copolymer containing from about 15 to about 45 weight % styrene, and about 45 to about 75 weight % total of a mixture of at least one aromatically modified C5 hydrocarbon tackifier resin having a softening point of from about 90 to about 100° C., and at least one styrenated terpene tackifier resin having a ring and ball softening point of from about 85 to about 100° C. The weight ratio of aromatically modified C5 hydrocarbon tackifier resin to styrenated terpene tackifier resin may, for example, be from about 3:1 to about 1:3. Such compositions are especially useful as a pressure sensitive hot melt adhesive in the construction of feminine hygiene articles.

The properties of a hot melt adhesive based on styrene/butadiene block copolymers are largely determined by its material compatibilities, bulk mechanical properties, and surface properties. The compatibilities of all the related ingredients for the hot melt adhesive and the related object substrate to which the adhesive is adhered are determined by the solubility parameter which is related to the surface free energy of each involved ingredient in the adhesive formulation. The bulk mechanical properties can be predicted by viscoelastic and failure testing methods, which together cover the small and large deformation modes. The surface properties are mainly determined by the surface energetics and the roughness of the related substrates. Where the substrate is a nonwoven, the surface energy of the substrate is generally greater than 39 dynes/cm or the substrate has a surface roughness which allows the molten hot melt adhesive to penetrate (wet out) the substrate and bond to the substrate by means of physical anchorage, within the desired open time.

The rheological methods which can be used to quantify the above adhesive properties are: Rheological Dynamic Analysis (or Temperature Sweep) and Rheological Creep/Recovery Analysis (or Creep Test), designed by ATS RheoSystems, located at Bordentown, N.J. The related parameters that concern pressure sensitive hot melt adhesive properties are:

For Temperature Sweep:

Three major parameters: G′, dynamic shear storage modulus; G″, dynamic shear loss modulus; and, Loss Tangent, or Tan Delta, a ratio for G″ divided by G′; can be obtained from a standard test procedure, for a temperature profile from −50 to 120 degrees C., frequency=0.01 to 15 Hz.

For Creep/Recovery Curve:

Bulk viscosity at low shear rate; J(t), creep compliance at equilibrium shear time, or G(t), shear modulus at equilibrium shear time, at the constant stress range from 1×10³ Pa to 8×10⁵ Pa. When the creep reaches steady face, the slope becomes steady shear viscosity, multiply by the compliance, equals to Viscosity J, at unit of (Pa·s 1/Pa).

The above viscoelastic parameters were introduced in John D. Ferry's book: Viscoelastic Properties of Polymers, 1980, 3rd Edition.

In certain embodiments, the hot melt pressure sensitive adhesives of the invention exhibit a G′ storage modulus, from Tg (glass transition temperature) to the temperature of G′=G″ or Tan Delta=1, in the range from about 1×10⁵ dynes/cm² to about 6×10⁶ dynes/cm².

In certain embodiments, the hot melt pressure sensitive adhesives of the invention exhibit a Loss Tangent (expressed as the ratio of G″/G′), from Tg (which is normally below room temperature) to the temperature of G′=G″ or Tan Delta=1, in the range from about 0.1 to about 4.0.

For Creep Resistance, the compliance J at creep section for certain embodiments of the adhesive of the present invention may be from about 1×10⁻⁵ l/Pa to about 1×10⁻³ l/Pa. The viscosity at the creep section may be from about 1×10⁵ Pa·s to about 1×10¹⁰ Pa·s under the following testing conditions: Constant Stress Range: 1×10² Pa to 7.5×10⁵ Pa, Creep Time: 60 Seconds to 6000 seconds, Recovery Time: 60 seconds to 6000 seconds.

The hot melt pressure sensitive adhesive of this invention may be prepared by mixing the components in a heated tank under vacuum at a temperature of from about 120° C. to about 190° C. until a homogeneous blend is obtained (usually within about 2 to 3 hours). The vacuum is then broken with nitrogen or carbon dioxide gas to prevent air entrapment in the adhesive. Using a minimum amount of thermal and mechanical energy to manufacture the adhesive and cooling the finished adhesive quickly to prevent degradation are additional useful procedures to employ. The finished adhesive is then packed in a suitable container and cooled. When the adhesive is to be used, it will generally be re-heated to a temperature effective to melt the adhesive and reduce its viscosity sufficiently to permit it to be applied to the surface of a substrate. Application of the adhesive in a molten state may be accomplished by any of the methods known in the hot melt adhesive art, including extrusion.

The hot melt pressure sensitive adhesives of the present invention are useful in a wide range of end use applications, including, for example, tapes, pre-applied labels, container labels, laminating, product assembly, positioning applications and the assembly of disposable articles. The adhesives may be utilized to bond many different types of materials such as polyolefin films (e.g., polyethylene and polypropylene films), polyolefin nonwovens (e.g., polyethylene and polypropylene nonwovens), polyurethane films, polyvinyl acetate films, polyvinyl chloride films, polyvinylidene chloride films, woven fabrics (including fabrics comprised of natural fibers and/or synthetic polymer fibers), absorbent materials (e.g., ceullosic pulp or fluff, superabsorbent batts), elastomeric materials (e.g., filaments, threads, bands or ribbons of elastic polymers), polyurethane foams, polyolefin foams, films or shaped articles of cellulose derivatives (e.g., tissues), films or shaped articles of acrylic resins such as polyacrylates and polymethacrylates, cellophane films, polyamide films, films or shaped articles of polyesters, materials based on starch or cellulose (e.g., paper sheets, tissue paper, wood, cardboard, particle board). Materials of the same type as well as materials of different types may be bonded or adhered to each other using the adhesive compositions described hereinabove. The adhesives are especially useful for the production of laminates, including, for example, film/film, film/nonwoven and nonwoven/nonwoven laminates. Articles that can be constructed using the adhesives of the present invention include disposable articles such as diapers, incontinent pads, bed pads, sanitary napkins, panty liners and the like. Pressure sensitive tapes and labels may also be produced by coating a layer of the pressure sensitive hot melt adhesive of the invention onto at least one of the main faces of a flexible backing sheet, which may be a web comprised of plastic, fiber and/or paper. The tape or label may comprise additional layers or coatings such as primers, release coatings, tie layers, printed inks, protective coatings or the like.

### I. EXAMPLES

TABLE 1
Tape & Label Hot Melt Pressure Sensitive Adhesives

| | | | | Example 4 |
|---|---|---|---|---|
| | Example | Example | Example | (Compara- |
| Raw Material | 1 | 2 | 3 | tive) |
| KRATON 1101¹ | 10 | 10 | 10 | N/A |
| SOLPRENE 1205² | 15 | 15 | 15 | N/A |
| TAIPOL 1307³ | N/A | N/A | N/A | 28 |
| NYFLEX 222B⁴ | 15 | 15 | 15 | 14 |
| ESCOREZ 1310 LC⁵ | N/A | N/A | N/A | 28.75 |
| SYVALITE RE 100L⁶ | 39.5 | 39.5 | 39.5 | 28.75 |
| ESCOREZ 2394⁷ | N/A | N/A | 20 | N/A |
| ESCOREZ 2596⁸ | 20 | N/A | N/A | N/A |
| WINGTACK 86⁹ | N/A | 20 | N/A | N/A |
| IRGANOX B-225¹⁰ | 0.5 | 0.5 | 0.5 | 0.5 |
| Total Parts by Weight | 100 | 100 | 100 | 100 |
| Viscosity @300° F. | 13100 | 13820 | 13120 | 12500 |
| | CPS | CPS | CPS | CPS |

Note:
All rheological data was collected using a temperature sweep from −50° C. to 110° C. at 3° C./minute at a fixed strain rate of 10 radians/second on an ATS stress-strain parallel plate rheometer with an 8 mm upper plate and a gap of 1 mm.
¹styrene/butadiene block copolymer containing 30 weight % styrene, 84 weight % linear S-B-S triblock, and 16 weight % S-B diblock and having an MFI of 1; obtained from Kraton Polymers
²styrene/butadiene copolymer containing 25 weight % styrene total (17.5 weight % in block form) and having a Mooney viscosity of 47 (ML1 + 4 100 degrees C.; according to ASTM D-1646); obtained from Dynasol Elastomers
³linear S-I-S triblock containing 15 weight % styrene and 18 weight % S-I diblock and having an MFI of 9; obtained from Taiwan Synthetic Rubber Corporation
⁴naphthenic oil plasticizer; obtained from Nynas
⁵aliphatic hydrocarbon tackifier resin having a ring and ball softening point of 91-97° C.; obtained from ExxonMobil Chemical
⁶pentaerythritol ester of rosin tackifier resin having a softening point of 96-102° C.; obtained from Arizona Chemical
⁷aromatic-modified aliphatic tackifier resin having a ring and ball softening point of 91-97° C.; obtained from ExxonMobil Chemical
⁸aromatic-modified aliphatic tackifier resin having a ring and ball softening point of 94-98° C.; obtained from ExxonMobil Chemical
⁹aromatic-modified C5 hydrocarbon tackifier resin having a softening point of 86° C., a number average molecular weight of 960 and a Tg (midpoint) of 42° C.; obtained from Goodyear Chemical
¹⁰stabilizer; obtained from Ciba Specialty Chemicals

### Example 1

A hot melt pressure sensitive adhesive in accordance with the invention and exhibiting good pressure sensitivity is formulated using the raw materials shown in Table 1, including a blend of linear S-B-S triblock copolymer containing 16 weight % S-B diblock and a styrene/butadiene copolymer (SOLPRENE 1205, a linear random-block styrene-butadiene copolymer containing 25 weight % of styrene with 17.5 weight % present as a polystyrene block and a Mooney viscosity of 47) exhibiting good pressure sensitivity. The glass transition temperature of the adhesive is 7.3° C. and the G′ is approximately 8×10⁵ dynes/cm² at 25° C. The viscosity of 13,100 mPas at 150° C. compares very favorably to control Example 4, which was formulated using only S-I-S block copolymer as the polymer component. The hot melt adhesive of this example is expected to be very useful for low temperature tape and label applications due to its low modulus G′ of approximately 5×10⁶ at temperatures below 0° C.

### Example 2

A hot melt pressure sensitive adhesive in accordance with the invention is formulated which differs from Example 1 with respect to the tackifier resin employed. Pressure sensitivity is good. The glass transition temperature is approximately 12° C. and the G′ is approximately 8.2×10⁵ at 25° C. This product is very useful as a general purpose HMPSA for tape and label applications. The viscosity compares favorably to that of the control containing S-I-S block copolymer (Example 4).

### Example 3

A hot melt pressure sensitive adhesive in accordance with the invention is formulated which differs from Examples 1 and 2 with respect to the tackifier resin employed. Pressure sensitivity is good. The glass transition temperature is approximately 12° C. and the G′ is approximately 4.0×10⁶ at 25° C. This product is expected to be very useful as a general purpose HMPSA for tape and label applications. The viscosity compares favorably to that of the control containing S-I-S block copolymer (Example 4).

### Example 4

Example 4 is a standard SIS-based general purpose HMPSA representing the present state of art, which is used for tape and label applications. The adhesive has a viscosity of 13,120 mPas at 150° C., a G′ of approximately 9.5×10⁵ at 25° C. and a Tg of 13° C. Although this type of product has found wide acceptance in the marketplace, it has become increasingly difficult to manufacture in recent years due to raw material availability issues.

TABLE 2
Disposable Nonwoven Construction Hot
Melt Pressure Sensitive Adhesives

| | | Example 6 |
|---|---|---|
| Raw Material | Example 5 | (Comparative) |
| NYFLEX 222B¹ | 15.5 | 23 |
| IRGANOX B-225² | 0.5 | 0.5 |
| VECTOR 4211³ | N/A | 10 |
| VECTOR 4113D⁴ | N/A | 6.5 |
| VECTOR 7400⁵ | 16 | N/A |
| SOL TE 6320⁶ | 5 | N/A |
| WINGTACK ET⁷ | 33 | 60 |
| SYLVALITE RE100L⁸ | 30 | N/A |
| Total Parts by Weight | 100 | 100 |
| Viscosity @300 F. | 3775 CPS | 1800 CPS |

¹naphthenic oil plasticizer; obtained from Nynas
²stabilizer; obtained from Ciba Specialty Chemicals
³linear SIS triblock copolymer containing 30 weight % styrene and less than 1 weight % diblock (MFR = 12 g/10 min); obtained from Dexco Polymers
⁴linear S-I-S triblock copolymer containing 15 weight % styrene and ca. 18 weight % S-I diblock; obtained from Dexco Polymers
⁵linear S-B-S triblock copolymer containing 30 weight % styrene (based on styrene/butadiene ratio), 33 weight % mineral oil and less than 1 weight % diblock and having an MFI of <1; obtained from Dexco Polymers
⁶styrene/butadiene copolymer containing 30 weight % styrene, 25 weight % S-B-S triblock, and 75 weight % S-B diblock; obtained from EniChem Elastomers
⁷aromatically modified C-5 hydrocarbon tackifier resin having a softening point of about 95.5° C., a number average molecular weight of 1080 and a Tg (midpoint) of 50° C.; obtained from Goodyear Chemical
⁸pentaerythritol ester rosin tackifier resin having a softening point of 96-102° C.; obtained from Arizona Chemical

### Example 5

This example (Table 2) illustrates an HMPSA in accordance with the present invention which is expected to be suitable for use in the construction of articles containing nonwoven fabrics. The adhesive product exhibits nearly the same level of tack and specific adhesion as measured by the relative height of the tan delta peak when plotted against temperature as the conventional HMPSA based on S-1-S block copolymers shown in Example 6.

### Example 6

This example (Table 2) represents a conventional hot melt adhesive based on S-1-S block copolymers which is useful for nonwoven lamination applications.

TABLE 3
Hot Melt Pressure Sensitive Adhesives Useful
for Disposable Nonwoven Elastic Attachment

| | | Example 8 |
|---|---|---|
| Raw Material | Example 7 | (Comparative) |
| NYFLEX 222B¹ | 12 | 15.5 |
| IRGANOX B225² | 0.5 | 0.5 |
| EASTOTAC H130L³ | N/A | 5 |
| KRISTALEX 5140⁴ | N/A | 5 |
| VECTOR 4215A⁵ | N/A | 15.5 |
| VECTOR 8508⁶ | N/A | 7 |
| WINGTACK ET⁷ | N/A | 15 |
| ESCOREZ 5400⁸ | N/A | 36.5 |
| STEREON 841A⁹ | 11 | N/A |
| VECTOR 7400¹⁰ | 12.5 | N/A |
| ESCOREZ 5615¹¹ | 21 | N/A |
| ESCOREZ 5600¹² | 43 | N/A |
| Total Parts by Weight | 100 | 100 |
| Viscosity @300° F. | 8500 | 5000 |
| | CPS | CPS |

¹naphthenic oil plasticizer; obtained from Nynas
²stabilizer; obtained from Ciba Specialty Chemicals
³hydrogenated aliphatic hydrocarbon tackifier resin having a ring & ball softening point of 130° C.; obtained from Eastman Chemical
⁴tackifier resin obtained from copolymerization of aromatic monomers having a number average molecular weight of 1450 and a ring & ball softening point of 137-143° C.; obtained from Eastman Chemical
⁵S-I-S block copolymer containing 30 weight % styrene and some S-I diblock and having an MFI of 9; obtained from Dexco Polymers
⁶linear S-B-S block copolymer containing 30 weight % styrene and having an MFI of 8; obtained from Dexco Polymers
⁷aromatically modified C-5 hydrocarbon tackifier resin having a softening point of about 95.5° C., a number average molecular weight of 1080 and a Tg (midpoint) of 50° C.; obtained from Goodyear Chemical
⁸cycloaliphatic hydrocarbon tackifier resin having a ring & ball softening point of 100-106° C., a number average molecular weight of 190, and a Tg = 50° C.; obtained from ExxonMobil Chemicals
⁹multi-block S-B-S block copolymer containing 44.5 weight % styrene and having a number average molecular weight of 67,000 and a weight average molecular weight of 94,000; obtained from Firestone Polymers
¹⁰linear S-B-S triblock copolymer containing 30 weight % styrene (based on styrene/butadiene ratio), 33 weight % mineral oil and less than 1 weight % S-B diblock and having an MFI of <1; obtained from Dexco Polymers
¹¹hydrogenated, aromatic-modified cycloaliphatic hydrocarbon tackifier resin having a ring & ball softening point of about 118° C., a number average molecular weight of 500, 10% aromaticity, and a Tg = 65° C.; obtained from ExxonMobil Chemicals
¹²aromatic-modified cycloaliphatic hydrocarbon tackifier resin having a ring & ball softening point of 100-106° C., a number average molecular weight of 270, 8-11% aromaticity, and a Tg = 48° C.; obtained from ExxonMobil Chemicals

### Example 7

This example (Table 3) illustrates a hot melt adhesive in accordance with the present invention which is useful in elastic attachment applications. The adhesive has similar properties similar to that of the control described in Example 8. Although it has a somewhat higher viscosity than the adhesive of Example 8, this is an advantage since less compression takes place when nipped to a poly-film, giving finer contact points and better elongation of the elastic. Additionally, the adhesive exhibits a higher modulus at 20° C. to 40° C., providing more creep-resistant bonds than the adhesive of control Example 8.

### Example 8

This example (Table 3) is a conventional adhesive useful in elastic attachment which is based on a blend of an S-I-S triblock copolymer and a linear S-B-S triblock copolymer.

TABLE 4
Hot Melt Pressure Sensitive Adhesives Useful
for Disposable Nonwoven Positioning

| | | Example 10 |
|---|---|---|
| Raw Material | Example 9 | (Comparative) |
| RENOIL 181¹ | N/A | 9 |
| NYFLEX 222B² | 19.5 | 21 |
| IRGANOX B225³ | 0.5 | 0.5 |
| CALPRENE H6120⁴ | N/A | 25 |
| ESCOREZ 5400⁵ | N/A | 44.5 |
| VECTOR 7400⁶ | 15 | N/A |
| SOL TE 6320⁷ | 6 | N/A |
| WINGTACK ET⁸ | 19 | N/A |
| SYLVARES ZT5100⁹ | 40 | N/A |
| Total Parts by Weight | 100 | 100 |
| Viscosity @300° F. | 3050 cps | 2900 cps |

¹technical white oil plasticizer; obtained from Renkert Oil Inc.
²naphthenic oil plasticizer; obtained from Nynas
³stabilizer; obtained from Ciba Specialty Chemicals
⁴linear ethylene-butylene/styrene block copolymer containing 30 weight % styrene; obtained from Dynasol
⁵cycloaliphatic hydrocarbon tackifier resin having a ring & ball softening point of 100-106° C., a number average molecular weight of 190, and a Tg = 50° C.; obtained from ExxonMobil Chemicals
⁶linear S-B-S triblock copolymer containing 30 weight % styrene (based on styrene/butadiene ratio) and less than 1 weight % S-B diblock and having an MFI of <1, extended with 33 weight % mineral oil; obtained from Dexco Polymers
⁷copolymer composition containing 30 weight % styrene, 25 weight % linear S-B-S triblock copolymer and 75 weight % S-B di-block; obtained from EniChem Elastomers
⁸aromatically modified C-5 hydrocarbon tackifier resin having a softening point of about 95.5° C., a number average molecular weight of 1080 and a Tg (midpoint) of 50° C.; obtained from Goodyear Chemical
⁹styrenated terpene tackifier resin having a softening point of about 90-96° C.; obtained from Arizona Chemical

### Example 9

This example (Table 4) illustrates a HMPSA in accordance with the present invention which is useful for the construction of feminine hygiene articles such as panty liners and sanitary napkins. Compared to the standard positioning HMPSA of Example 10, the adhesive has better transfer resistance as shown by a higher G′ storage modulus at 25° C. and a broader Tg.

### Example 10

Example 10 (Table 4) is a conventional positioning HMPSA based on S-EB-S triblock copolymer.

What is claimed is:

1. A hot melt pressure sensitive adhesive composition comprised of:
a) at least one styrene/butadiene block copolymer having a melt flow index of less than about 12, a linear triblock structure, and a styrene content of about 20 to about 35 weight percent;
b) at least one butadiene-based polymer selected from the group consisting of (i) styrene/butadiene random copolymers containing about 15 to about 35 weight percent styrene, (ii) styrene/butadiene multiblock copolymers containing about 35 to about 55 weight percent styrene and (iii) styrene/butadiene diblock copolymers containing about 15 to about 45 weight percent styrene;
c) at least one tackifier resin;
d) optionally, at least one plasticizer;
e) optionally, at least one filler;
f) optionally, at least one wax; and
g) optionally, at least one stabilizer and/or UV-absorber.

2. The composition of claim 1 wherein said at least one tackifier resin has a ring and ball softening point of from about 80° C. to 125° C. and is selected from the group consisting of pentaerythritol esters of rosin, aromatically-modified aliphatic and cycloaliphatic resins, hydrogenated aromatically-modified cycloaliphatic resins, styrenated terpene resins and mixtures thereof.

3. The composition of claim 1 comprising about 5 to about 25 weight % of component a), about 1 to about 25 weight % of component b), about 30 to about 80 weight % of component c), and about 1 to about 30 weight % of component d).

4. The composition of claim 1 comprising about 7 to about 20 weight % of component a), about 2 to about 20 weight % of component b), about 50 to about 75 weight % of component c), and about 5 to about 25 weight % of component d).

5. The composition of claim 1 wherein said at least one tackifier is selected from the group consisting of C5-C9 hydrocarbon tackifier resins and aromatically-modified C5 hydrocarbon tackifier resins containing about 10 to about 30 weight % of at least one compound selected from the group consisting of C9 and vinyl aromatic compounds, said tackifier having a glass transition temperature of from about 15° C. to about 45° C. and a ring and ball softening point of from about 20° C. to about 90° C.

6. The composition of claim 1 wherein said at least one tackifier is selected from the group consisting of C5-C9 hydrocarbon tackifier resins and aromatically-modified C5 hydrocarbon tackifier resins containing about 18 to about 24 weight % of at least one vinyl aromatic compound, said tackifier having a glass transition temperature of from about 32° C. to about 38° C. and a ring and ball softening point of from about 60° C. to about 80° C.

7. The composition of claim 1, wherein said composition is comprised of from about 6 to about 12 weight % linear S-B-S triblock copolymer containing about 25 to about 35 weight % styrene and having an MFI of less than about 2 g/10 min, about 11 to about 19 weight % of a random styrene/butadiene copolymer containing about 20 to about 30 weight % styrene and having a Mooney viscosity of from about 35 to about 60, about 11 to about 19 weight % of a hydrocarbon oil plasticizer, about 30 to about 49 weight % of a pentaerythritol ester of rosin tackifier resin having a ring and ball softening point of from about 90 to about 105° C., and about 15 to about 25 weight % of an aromatic-modified aliphatic tackifier resin having a ring and ball softening point of from about 85 to about 100° C.

8. The composition of claim 1, wherein said composition is comprised of about 16 weight % to about 27 weight % of hydrocarbon oil plasticizer, about 9 to about 15 weight % of a linear S-B-S triblock copolymer containing about 25 to about 35 weight % styrene and having an MFI of less than about 2 g/10 min, about 1 to about 6 weight % of an S-B diblock copolymer containing from about 15 to about 45 weight % styrene, and about 45 to about 80 weight % total of a mixture of at least one aromatically-modified C5 hydrocarbon tackifier resin having a softening point of from about 90 to about 100° C., and at least one pentaerythritol ester of rosin tackifier resin having a softening point of from about 90 to about 105° C.

9. The composition of claim 1, wherein said composition is comprised of about 10 to about 18 weight % hydrocarbon oil plasticizer, about 6 to about 13 weight % of a linear multiblock styrene/butadiene block copolymer containing about 40 to about 50 weight % styrene, about 6 to about 11 weight % of a linear S-B-S triblock copolymer containing about 25 to about 35 weight % styrene and having an MFI of less than about 2 g/10 min, and about 50 to about 85 weight % of one or more aromatically-modified cycloaliphatic hydrocarbon tackifier resins having ring and ball softening points of from about 95 to about 125° C.

10. The composition of claim 1, wherein said composition is comprised of about 19 to about 32 weight % of hydrocarbon oil plasticizer, about 9 to about 15 weight % of a linear S-B-S triblock copolymer containing about 25 to about 35 weight % styrene and having an MFI of less than about 2 g/10 min, about 1 to about 4 weight % of an S-B diblock copolymer containing from about 15 to about 45 weight % styrene, and about 45 to about 75 weight % total of a mixture of at least one aromatically modified C5 hydrocarbon tackifier resin having a softening point of from about 90 to about 100° C., and at least one styrenated terpene tackifier resin having a ring and ball softening point of from about 85 to about 100° C.

11. The composition of claim 1, wherein said composition has a viscosity of from about 500 mPa·s to about 250,000 mPa·s at 150° C.

12. The composition of claim 1, wherein said composition has a glass transition temperature of from about −20 to about 30° C.

13. The composition of claim 1, wherein said composition has a G′ of from about 1×10⁵ to about 6×10⁶ dynes per cm² at 25° C.

14. The composition of claim 1, wherein said composition comprises at least one styrene/butadiene random copolymer containing a portion of polymerized styrene in block or homopolymer form.

15. The composition of claim 1, wherein said composition comprises at least one styrene/butadiene random copolymer containing 15 to 35 weight percent styrene and the weight ratio of component a): styrene/butadiene random copolymer is from about 1.5:1 to about 1:3.

16. The composition of claim 1, wherein said composition comprises at least one styrene/butadiene multiblock copolymer containing 35 to 55 weight percent styrene and the weight ratio of component a): styrene/butadiene multiblock copolymer is from about 2:1 to about 1:3.

17. The composition of claim 1, wherein said composition comprises at least one S-B diblock compolymer containing from about 15 to about 45 weight % styrene and the weight ratio of said component a): said S-B diblock copolymer is from about 8:1 to about 1:1.

18. The composition of claim 1, wherein the weight ratio of component a): component b) is from about 10:1 to about 1:5.

19. A method of bonding a first substrate to a second substrate with an adhesive, said method comprising using the composition of claim 1 as said adhesive.

20. A method of producing a pressure sensitive tape or label, said method comprising forming a coating of the composition of claim 1 on a primary surface of a flexible backing.
